(19) United States
(12) Patent Application Publication
(10) Pub. No.: US 2016/0171740 A1
(43) Pub. Date: Jun. 16, 2016

(54) REAL-TIME METHOD FOR COLLABORATIVE ANIMATION

(71) Applicant: Calay Venture S.à r.l., Bettembourg (LU)

(72) Inventor: Cevat Yerli, Frankfurt am Main (DE)

(21) Appl. No.: 14/570,957

(22) Filed: Dec. 15, 2014

(51) Int. Cl. G06T 13/80; G06T 1/20; G06T 13/20

(52) U.S. Cl. CPC G06T 13/80; G06T 13/20; G06T 1/20; G06T 2213/08

(57) ABSTRACT

A method for collaborative animation comprises maintaining a model of an animated scene, establishing real-time links to a plurality of client devices; continuously receiving updates from the plurality of client devices, each update associated with an animation aspect; updating the model with a processing stack based on the received updates in a plurality of iterations, each iteration using updates associated with one animation aspect; and distributing indications of the updated model via the real-time links to the plurality of client devices. Furthermore, an animation apparatus and a distributed animation system are described.

### TECHNICAL FIELD

The present disclosure relates to a method for collaborative animation, an animation apparatus and a distributed animation system enabling collaborative animation of animated scenes.

### BACKGROUND

Animation is directed at creating an illusion of a changing motion or shape of objects in an animated scene, which is typically achieved by a rapid display of a sequence of static images that reflect the respective changes. Animations are typically created digitally on a computer using 2D or 3D animation techniques, which usually build 2D or 3D virtual worlds or scenes in which characters and objects move and interact. Computer-based animation typically requires dedicated computing resources to compute the individual images for the animation, wherein the time for preparing the images rapidly increases with a desired level of realism of the final image.

The individual objects of the animated scenes can be modeled and manipulated by an animator. Furthermore, collaboration between several animators may be achieved by an exchange of intermediate animation results that typically interrupt the work process and require additional time to complete the animation. Usually, an animator may start by creating 3D polygon meshes including vertices that may be connected by edges to generate a visual appearance of objects in the 2D or 3D scene. Furthermore, control structures may be applied, such as bounding boxes or skeletal structures that can be used to control the meshes, for example, by weighting respective vertices. Other techniques, such as simulations of gravity, particle simulations, simulated skin, fur, or hair, and effects such as fire and water simulation and other approaches directed at 3D dynamics can be applied during the animation procedure in order to create a realistic animation of a scene.

The processing of large animation projects, such as animated films, may be very time consuming and expensive. The production process may require many different types of specialist workers or animators and a great many man hours to produce the film. Furthermore, current production processes typically have a sequential nature. Concurrent activities between various specialist workers or animators are either not possible or strongly limited.

### SUMMARY

The above problem is solved by a method for collaborative animation, an animation apparatus, and a distributed animation system as disclosed herein. Aspects of the present disclosure enable collaborative animation in real time to generate animations with a desired level of realism.

According to a first aspect of the present disclosure, a method for collaborative animation is provided, which comprises maintaining a model of an animated scene; establishing real-time links to a plurality of client devices; continuously receiving updates from the plurality of client devices, each associated with an animation aspect; updating the model with the processing stack based on the received updates in a plurality of iterations, each iteration using updates associated with one animation aspect; and distributing indications of the updated model via the real-time links to the plurality of client devices.

The method, which is preferably a computer-implemented method, enables an animation of a scene via a plurality of client devices, which may collaboratively contribute to the animated scene based on updates which are provided via respective real-time links and processed using a processing stack in order to contribute to the animated scene. In response, individual data reflecting the updated model are redistributed to the individual client devices via the real-time links. Hence, the required resources can be distributed over a variety of individual client devices which may be dedicated to individual aspects of the animation. This enables an efficient creation of animations, wherein results are directly fed back to individual client devices in order to provide a local animator with an updated local model of the animated scene on the respective client device.

Preferably, the model of the animated scene comprises a plurality of animation objects. The animation objects may be arranged according to a scene graph and may comprise data of respective animation objects reflecting their visual and/or auditory properties or any further property according to another modality, which may be defined in any suitable dimension corresponding to the animated scene, such as in two dimensions (2D) or three dimensions (3D). Furthermore, the animated scene and the plurality of animation objects may comprise data reflecting changes of the animated scene or animation objects over time.

In one embodiment, each client device provides updates for the model according to one animation aspect. Preferably, the animation aspects may correspond to different types of data and/or different parts of the animated scene and/or different modalities. The animation aspects may refer to data directed at a structure or form of individual objects or a group of objects of the animated scene, changes in motion or form of parts of the animated scene, audio data, special effects or simulation of dynamics, sound animation and/or simulation, light animation and/or simulation, or individual frames or groups of video frames of a resulting animation. However, it is to be understood that these exemplifying aspects are not exhaustive and any further animation aspect, such as simulation/animation of other physical properties, such as simulation of water, hair, or fur, are fully encompassed by the present disclosure. Each client device may be dedicated to one animation aspect. Furthermore, each client device may provide updates for a different animation aspect. Hence, the collaborative animation can be divided into a plurality of animation aspects and each client device may be configured to provide updates for one or more of the animation aspects. Each client device may execute a corresponding application for digital content creation (DCC application) in order to provide the updates and to receive the indications of the updated model. For example the DCC application may be configured to process the animated scene according to the one or more animation aspects of the client device.

In a further embodiment of the present disclosure, each update includes data of the animation aspect for at least one animation object of the animated scene. For example, on a client device, the respective animator may change animation data for one or more animation objects according to the animation aspect of the client device. The updates may be either directly sent via the real-time link to contribute to the animated scene or may be sent after the animator has confirmed the local animation results. For example, the animator may modify the structure or appearance of individual animation objects, for example, by changing individual vertices or affecting respective control structures, and may define respective variations in time for the individual changes. The animator may confirm the changes and the local DCC application may analyze the changes and provide respective update information via the real-time link. Furthermore, the local DCC application may receive the redistributed indications of the updated model via the real-time link and may directly update the local model of the animated scene. The DCC application may also provide means for resolving local conflicts if the received indications of the updated model affect animation objects of the animated scene which the animator is currently working on at the local client device. Either the indications may override any local model in order to guarantee a consistency of the (central) model of the animated scene and the differences may be incorporated into the current work of the animator on the local copy of the model, or the animator may be presented with an interface indicating possible conflicts and providing input means reflecting various situations on how to resolve each conflict. If the animator elects the local changes to override received indications of the updated model, these changes may be represented as another update of the model and sent via the real-time link for updating the (central) model of the animated scene. The DCC application and/or the application maintaining the (central) model of the animated scene may comprise further means to resolve any conflicts which may take into account a division or partitioning of the mode of the animated scene into the plurality of animation aspects. Preferably, if the animation aspects define disjunct parts of the model of the animated scene, conflicts can be further reduced or even completely avoided.

In a further embodiment, updating the model includes sorting updates received during a predetermined period of time according to associated animation aspects. The receiving of updates may be performed continuously and may be subdivided into predetermined periods of time, such as time slices of the same length. However, the predetermined periods of time may also have a variable length which may, for example, depend on a number of received updates or which may be responsive to a current processing load of the processing stack. The processing stack may maintain a list of animation aspects and all received updates within the predetermined period of time may be sorted according to the animation aspects in the list.

In yet another embodiment, updating the model further includes determining the animation aspect of a current iteration and selecting updates associated with the animation aspect. Each iteration of the processing stack may correspond to a level of the processing stack and may handle a single animation aspect only. For example, the processing stack may handle N animation aspects, which may be sequentially processed in iterations 0, . . . , N−1, respectively, and the processing may re-iterate in iteration N with processing of the first animation aspect. The processing stack may be further configured to skip individual iterations, if no updates for the animation aspect are enqueued. For example, if no update for the animation aspect has been received during a current time slice or a current predetermined period of time or until the current iteration has started, the processing stack may skip the current iteration. Therefore, the iterations for the individual animation aspects need not strictly re-iterate after N iterations since individual iterations may be skipped.

In a further embodiment, the method further comprises delaying processing of updates associated with an animation aspect until the processing stack starts an iteration for the animation aspect. Hence, the model of the animated scene is not directly affected by each individual update, but follows the sequential processing of the processing stack. The processing stack may pre-process the updates directed at single animation aspects in order to update the model, such as sorting, consolidating or combining individual updates. This may lead to a more efficient processing of the update procedure. Furthermore, since the update is based on individual aspects only, real-time feedback during animation of the animated scene for individual animators is achieved.

In yet another embodiment, the method further comprises determining an animation aspect of a client device and adding the animation aspect to a list of animation aspects of the animated scene if the animation aspect is not included in the list of animation aspects of the animated scene. The collaborative animation according to the present disclosure is highly flexible with regard to new and existing client devices, which may dynamically connect via respective real-time links to the (central) model of the animated scene in order to provide updates according to respective animation aspects. Connected client devices may also change their animation aspect, thereby allowing for re-partitioning of the animation into possibly new animation aspects.

In yet another embodiment, the method further comprises extending the iterations of the processing stack with an iteration for the added animation aspect. As soon as a new client device connects via a real-time link or as soon as a client device of the plurality of client devices changes the animation aspect, the method may verify whether the animation aspect of the new client device or the changed animation aspect is included in the list of animation aspects of the animated scene and if not, the new animation aspect may be included into the list of animation aspects. Furthermore, if an animation aspect is changed, the previous animation aspect may be removed from the list of animation aspects if no further client device handles the previous animation aspect. After an update of the list of animation aspects, the processing stack may be reconfigured to iterate over items of the new list of animation aspects. This allows for a highly dynamic and flexible collaborative animation approach, which is adaptable to new configurations of an animation project with regard to animation aspects as well as client devices handling new animation aspects.

In yet another embodiment, distributing indications includes, for a client device associated with an animation aspect, selecting indications of the updated model for the animated aspect and distributing the selected indications to the client device. The selected indications may be provided to the client device with a higher priority via the real-time link. This enables instantaneous feedback on respective client devices reflecting current updates of the model. Since the local DCC applications on respective client devices are dedicated to individual animation aspects, the selected indications will most likely reflect data the animator is most interested in. Any further indications may be subsequently provided to the client device with a lower priority. However, if the DCC application only handles one animation aspect, the DCC application need not receive any further data related to other animation aspects of the scene. Hence, preferably, only the selected indications may be distributed to individual client devices. For example, a DCC application may be dedicated to audio content of the animation, in which case updates of a physical simulation of the model of the animated scene need not be distributed to the audio DCC application.

In yet another embodiment, the indications of the updated model are distributed to continuously synchronize the animated scene on the client devices. Hence, the local models of the animated scene on the individual client devices may be consistent with the (central) model of the animated scene. Both the application handling the (central) model and the local applications handling the local models of the animated scene may comprise means for resolving conflicts, wherein the (central) model may be handled with a higher priority, as discussed above.

According to another embodiment, the real-time link is a dedicated connection to the respective client device configured to transmit the updates and the indications of the updated model. The real-time link may be a network connection using a standard communication protocol, which may be continuously checked for sufficient performance and speed, such as using a real-time transport protocol or other approaches. The real-time link may, however, also be a dedicated communication link, which may use a direct connection to the client device, such as wired or wireless connection using a dedicated network.

In a further embodiment, the processing stack is executed by an engine. An engine may be implemented in hardware or software or a combination of hardware and software, such as using dedicated processors configured to execute the engine. The engine may be a continuation-based construct that provides timed preemption. Accordingly, the processing stack may be implemented using dedicated modules or program code for the engine to provide an iterative processing of updates according to animation aspects in a plurality of iterations. This ensures a real-time processing of updates and a real-time feedback on updates of the model.

In yet another embodiment, the engine is executed on a host device or on one of the plurality of client devices. Hence, the client devices may communicate, via the real-time links, with the host device, which may execute a respective host application and the engine to maintain and update the model of the animated scene centrally. However, one of the client devices may also be elected according to a negotiation procedure or according to pre-set parameters as the client device hosting the central model of the animated scene. For example, a group of peer client devices may connect to each other and may negotiate or use respective parameters to determine a client device which may act as the host device and maintain the central model of the animated scene. Thereafter, the host device may establish the real-time links to the other client devices in order to enable a collaborative animation according to embodiments of the present disclosure. Furthermore, the host device may itself act as a client device providing updates for the model of the animated scene, such as by concurrently executing the host application and a DCC application for the collaborative animation process.

In yet another embodiment, the collaborative animation is directed at producing an animated film.

According to a further aspect, a non-transitory computer-readable medium having instructions stored thereon is provided, wherein said instructions, in response to their execution by a computing device, cause said computing device to automatically perform a method for collaborative animation according to one embodiment of the present disclosure. In particular, the instructions may cause said computing device to automatically perform a method including maintaining a model of an animated scene, establishing real-time links to a plurality of client devices, continuously receiving updates from the plurality of client devices, each update associated with an animation aspect, updating the model with a processing stack based on the received updates in a plurality of iterations, each iteration using updates associated with one animation aspect, and distributing indications of the updated model via the real-time links to the plurality of client devices.

Individual processing of the method according to embodiments of the present disclosure may be performed by a processor or a dedicated processor, such as dedicated hardware. Furthermore, respective processing steps may correspond to instructions, which may be stored in memory and the processor or dedicated processor may be configured according to the stored instructions to perform the method according to embodiments of the present disclosure.

According to a further aspect of the present disclosure, an animation apparatus comprising a processor is provided, wherein the processor is configured to perform a method for collaborative animation according to embodiments of the present disclosure. In particular, the processor may be configured to maintain a model of an animated scene, establish real-time links to a plurality of client devices, continuously receive updates from the plurality of client devices, each update associated with an animation aspect, update the model with a processing stack based on the received updates in a plurality of iterations, each iteration using updates associated with one animation aspect, and distribute indications of the updated model via the real-time links to the plurality of client devices. Furthermore, the animation apparatus may comprise memory, which may store instructions that, when executed by the processor, configure the processor and/or the animation apparatus to perform a method for collaborative animation according to embodiments of the present disclosure.

According to one embodiment, the animation apparatus further comprises one or more dedicated processors, such as a graphics processing unit, which may be configured to implement one or more iterations of the processing stack and/or individual processing tasks of the updating procedure of the model according to individual animation aspects. The execution of the processing stack in a particular iteration may directly provide the data to the dedicated processor to update the model. For example, the animation apparatus may comprise a graphics processing unit (GPU), which may be configured to process one or more iterations of the processing stack by exploiting the dedicated hardware architecture of the GPU, such as highly parallel structures of the GPU.

In yet another embodiment, the processor or the dedicated processor are configured to execute a real-time graphics engine. The real-time graphics engine may be the CryEngine available from Crytek GmbH.

According to yet another aspect, a distributed animation system is provided, comprising a host device configured to maintain a model of an animated scene, and a plurality of client devices connected to the host device via real-time links, wherein the host device is configured to perform a method for collaborative animation according to embodiments of the present disclosure. For example, the host device may be configured to establish the real-time links to the plurality of client devices; continuously receive updates from the plurality of client devices, each update associated with an animation aspect; update the model with the processing stack based on the received updates in a plurality of iterations, each iteration using updates associated with one animation aspect; and distribute indications of the updated model via the real-time links to the plurality of client devices.

According to one embodiment, each client device may execute an application enabling an animator to animate a local model of the animated scene according to one or more animation aspects, which local model may correspond to the model maintained centrally on the host device. Throughout this application, the model maintained by the host device may also be referred to as the central model, in contrast to local models maintained on individual client devices. The application may be a DCC application, such as an animation 3D graphics software, which may contribute to the animation project according to one or more animation aspects. Preferably, each client device provides updates according to one animation aspect and/or each client device may provide updates according to a different animation aspect.

A client device according to embodiments of the present disclosure may be a computing device or a dedicated hardware device, such as a computer, a laptop, a mobile device, or even a smart phone, which may execute a respective DCC application for contributing to an animation project.

### BRIEF DESCRIPTION OF THE DRAWINGS

Specific features, aspects and advantages of the present disclosure will be better understood with regard to the following description and accompanying drawings, where:

FIG. 1 illustrates a flow chart of a method according to an embodiment of the present disclosure;

FIG. 2 shows a schematic diagram of a system according to an embodiment of the present disclosure;

FIG. 3 shows a schematic diagram of processing of a system according to an embodiment of the present disclosure; and

FIG. 4 shows a sequence of processing of a system according to an embodiment of the present disclosure.

### DETAILED DESCRIPTION

In the following description, reference is made to drawings that show by way of illustration various embodiments of the present disclosure. Also, various embodiments will be described below by referring to several examples. It is to be understood that the embodiments may include changes in design and structure without departing from the scope of the claimed subject matter.

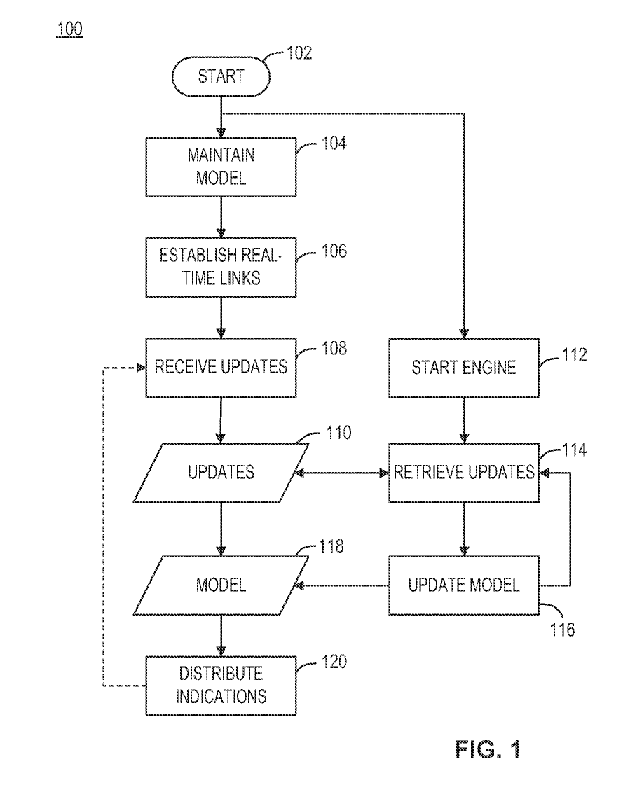

FIG. 1 shows a flow chart of a method for collaborative animation according to one embodiment of the present disclosure. The computer-implemented method 100 may start 102 and may continue with item 104, wherein a model of an animated scene may be maintained. The model of the animated scene may comprise a plurality of animation objects, respective data for one or more modalities as well as variations in time according to two, three, four or more dimensions.

The method may continue with item 106, wherein real-time links may be established to a plurality of client devices. In subsequent item 108, updates 110 from the plurality of client devices may be continuously received. Each update 110 may be associated with an animation aspect.

Furthermore, after initiation of the method 100, an engine may be started, which may implement a processing stack, in item 112. The engine may be started 112 independently of any further processing of the method in items 104 to 108. The engine may be, for example, started as an individual thread or executed concurrently or in parallel on a dedicated processor or hardware. The processing stack of the engine may retrieve the updates 110 in step 114 according to individual animation aspects and may update the model based on the retrieved updates 110 in a plurality of iterations in item 116, wherein each iteration may use updates 110 associated with one animation aspect. Processing of item 116 may lead to an updated model 118.

The method 100 may proceed with item 120, wherein indications of the updated model 118 may be re-distributed or fed back via the real-time links to the plurality of client devices.

The method 100 may end in response to a terminating instruction any time during execution of the method 100. Furthermore, as soon as the terminating instruction is received, the engine may be stopped and respective updates 110 or the updated model 118 may be stored for later processing.

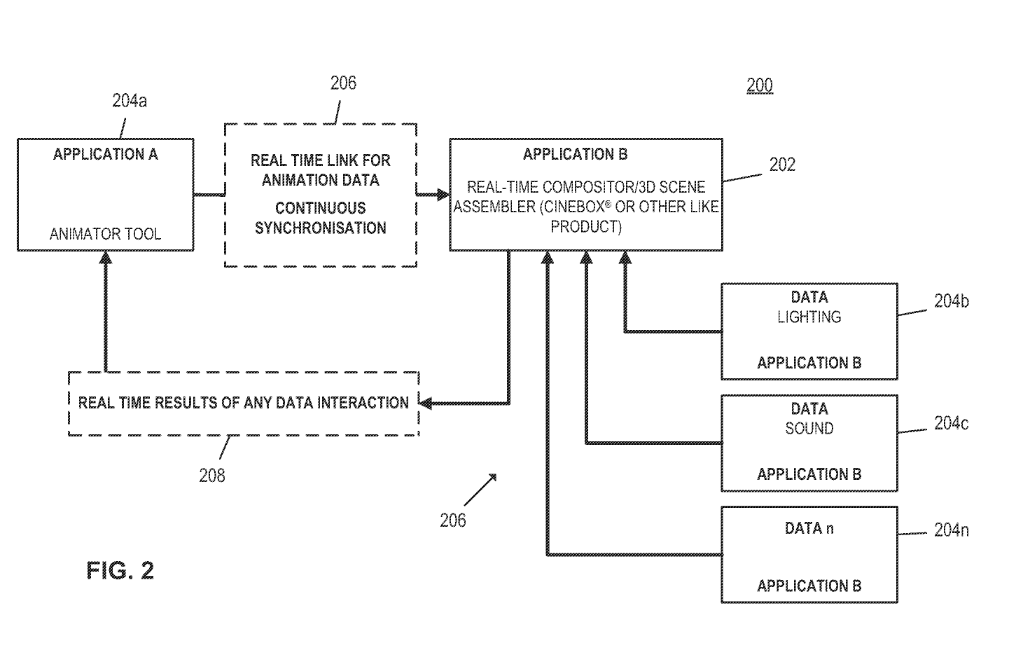

The method 100 allows typical animation 3D graphics software executed on individual client devices to be linked in real time and continuously synchronized into a real-time compositor, or a 3D scene assembler or similar application, which may be executed on a host device maintaining the central model. This allows for a concurrent collaboration between different animators or creative specialists in real time. FIG. 2 illustrates a schematic view of a system according to one embodiment of the present disclosure. The distributed animation system 200 may include a host device 202 which may execute an application, such as a real-time compositor or 3D scene assembler which may maintain a model of an animated scene. The compositor may be, for example, Cinebox available from Crytek GmbH or other like product. The host device 202 may be connected to a plurality of client devices 204a-n via real-time links 206. The host device 202 may be configured to continuously receive updates from the plurality of client devices 204a-n via the real-time links 206 and may use the compositor/assembler to update the model using a processing stack based on the received updates in a plurality of iterations. The real-time links 206 may be continuous links between the client devices 204a-n to the host device 202.

Each update may be directed at an animation aspect of the client devices 204a-n, for example, client device 204a may execute a DCC application, which may be an animator tool, client device 204b may execute a DCC application, which may provide data for lighting simulation/animation, and client device 204c may provide data for sound simulation/animation via respective real-time links 206. The results 208 of the update may be redistributed via the real-time links 206 back to the client devices 204a-n. Hence, DCC applications may be specific to individual computer graphics content and may include, for example, camera data, animation data, lighting data, sound data, and others. This enables an integration of a broad variety of hardware and/or software into the collaborative approach for animated projects. The client devices 204a-n may be interconnected via real-time links 206 to enable a live streaming between different clients 204a-n.

Even though sending of updates via real-time links 206 and distributing results 208 from and to client device 204a are shown as two separate connections, it is to be understood that even though both connections may represent individual channels within the real-time link 206, client device 204a may also be connected to the host device 202 via a plurality of real-time links, which may be dedicated upstream or downstream links for respective data.

The animation system 200 brings together preparatory 3D computer graphics software, such as 3dsMax, Maya and the like into a real-time compositor or 3D scene assembler, such as Cinebox or other similar products. This is achieved via the real-time links 206, whereby any animation data from the client devices 204a-n may be continuously synchronized and fed into the real-time compositor or 3D scene assembler on the host device 202. This enables real-time collaboration between many different animators or specialist workers, such as artists, scene modelers, lighting and FX experts, operating respective client devices 204a-n. This results in all animators being able to see in real time within the real-time compositor or 3D scene assembler the results of each other's concurrent activity in the animated scene or its parts, such as characters, objects and respective animations in the animated scene of the animation project. Accordingly, a flexible and fast concurrent working methodology is provided which may deliver animations with any desired level of realism in real time.

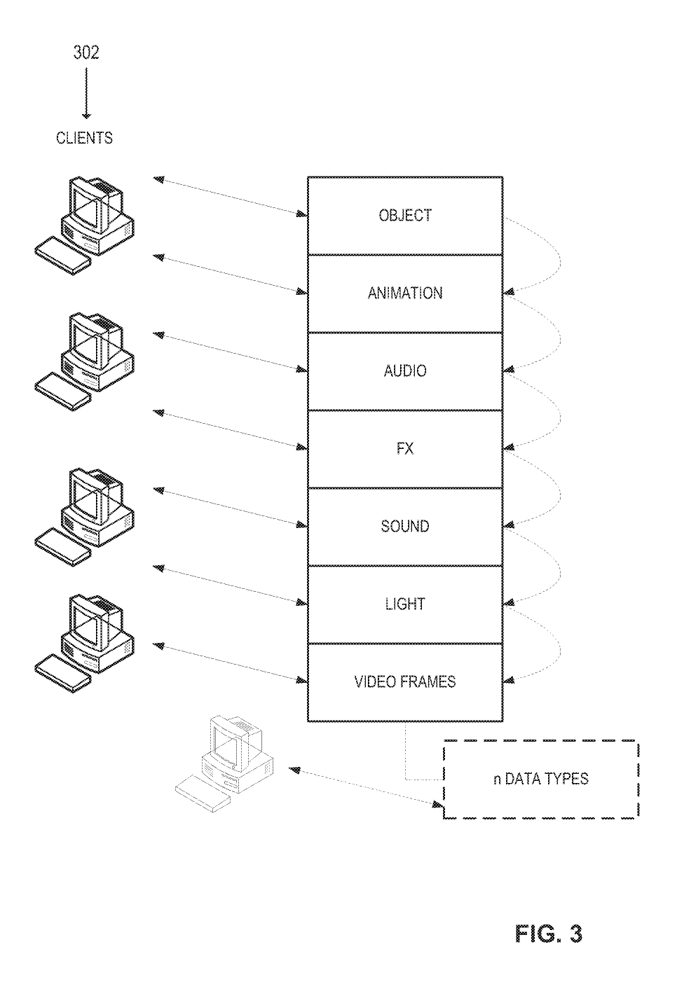

FIG. 3 shows a schematic diagram of processing of a system according to one embodiment of the present disclosure. A plurality of clients 302, which may correspond to the client devices 204a-n in FIG. 2, may provide updates related to individual animation aspects. Animation aspects may, for example, include object data, animation data, audio data, special effects (FX) data, sound data, light data and data related to individual video frames. The animation aspects and respective updates may be processed sequentially by a processing stack or engine in multiple iterations, each iteration using updates associated with one of the animation aspects. The update loop of the processing stack or engine may be re-iterated and after each loop, the results may be redistributed to the clients 302. Hence, the different types of data may be processed sequentially, wherein the processing stack or engine may sequentially process different types of data. For example, types of data corresponding to animation aspects may be ordered in a table, and the processing stack or engine may process the data on a row-by-row basis, wherein each row may represent a type of data corresponding to an animation aspect.

As shown in FIG. 3, if an update from a particular client 302 misses an iteration for its animation aspect or type of data, the processing of the update may be delayed until the next loop of iterations is executed. This may ensure a continuous flow of updates for a variety of different data types from individual clients 302.

The processing stack or engine may be located and executed in a master application on a dedicated host device, such as a server, or locally on one of the clients 302, which may connect to other clients 302 and respective applications supplying the individual data via real-time links.

The redistribution of results of the update of the model may be selective, wherein a client only gets the results according to an animation aspect that the client is pushing into the processing stack or engine. For example, a sound client may only receive sound updates.

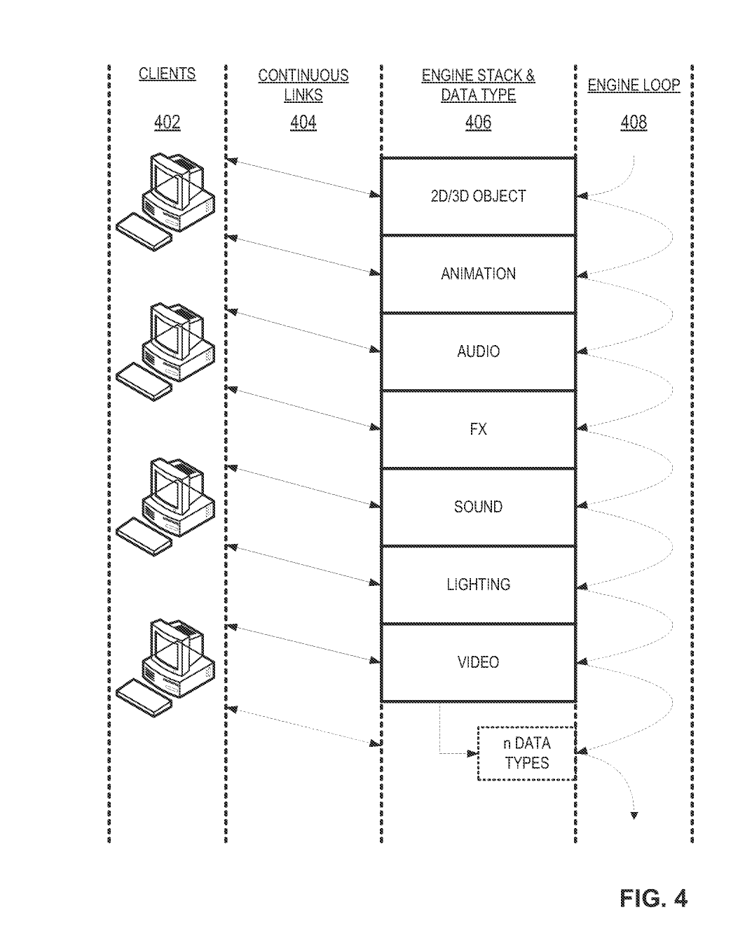

FIG. 4 shows a processing flow of a system according to one embodiment of the present disclosure. A plurality of clients 402, which may be the clients 302 of FIG. 3 or the client devices 204a-n of FIG. 2, may supply updates for an animation project directed at a model of an animated scene according to individual animation aspects via continuous links 404, which may be individual real-time links, such as the real-time links 206 of FIG. 2.

An engine or processing stack 406 may be executed on a host device or server, such as the host device 202 of FIG. 2, wherein the processing stack 406 may process the updates according to individual animation aspects of the animation project. The processing stack 406 may have multiple levels, each level corresponding to an individual animation aspect. The processing stack 406 may re-iterate the levels in subsequent loops 408. The individual levels of processing stack 406 may, for example, address 2D/3D objects, animation, audio, FX, sound, lighting and/or video data and/or any further animation aspect of the animation project and/or the animated scene.

While some embodiments have been described in detail, it is to be understood that aspects of the disclosure can take many forms. In particular, the claimed subject matter may be practiced or implemented differently from the examples described, and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A method for collaborative animation, comprising:
maintaining a model of an animated scene;
establishing real-time links to a plurality of client devices;
continuously receiving updates from the plurality of client devices, each update associated with an animation aspect;
updating the model with a processing stack based on the received updates in a plurality of iterations, each iteration using updates associated with one animation aspect; and
distributing indications of the updated model via the real-time links to the plurality of client devices.

2. The method according to claim 1, wherein each client device provides updates for the model according to one animation aspect.

3. The method according to claim 1, wherein each update includes data of the animation aspect for at least one animation object of the animated scene.

4. The method according to claim 1, wherein updating the model includes sorting updates received during a predetermined period of time according to associated animation aspects.

5. The method according to claim 1, wherein updating the model further includes determining the animation aspect of a current iteration and selecting updates associated with the animation aspect.

6. The method according to claim 1, further comprising delaying processing of updates associated with an animation aspect until the processing stack starts an iteration for the animation aspect.

7. The method according to claim 1, further comprising determining an animation aspect of a client device and adding the animation aspect to a list of animation aspects of the animated scene if the animation aspect is not included in the list of animation aspects of the animated scene.

8. The method according to claim 7, further comprising extending the iterations of the processing stack with an iteration for the added animation aspect.

9. The method according to claim 1, wherein each animation aspect corresponds to a different type of data.

10. The method according to claim 1, wherein distributing indications includes, for a client device associated with an animation aspect, selecting indications of the updated model for the animation aspect and only distributing the selected indications to the client device.

11. The method according to claim 1, wherein the indications of the updated model are distributed to continuously synchronize the animated scene on the client devices.

12. The method according to claim 1, wherein the real-time link is a dedicated connection to the respective client device configured to transmit the updates and the indications of the updated model.

13. The method according to claim 1, wherein the processing stack is executed by an engine.

14. The method according to claim 13, wherein the engine is executed on a host device or on one of the plurality of client devices.

15. The method according to claim 1, wherein the collaborative animation is directed at producing an animated film.

16. An animation apparatus comprising:
a processor configured to:
maintain a model of an animated scene;
establish real-time links to a plurality of client devices;
continuously receive updates from the plurality of client devices, each update associated with an animation aspect;
update the model with a processing stack based on the received updates in a plurality of iterations, each iteration using updates associated with one animation aspect; and
distribute indications of the updated model via the real-time links to the plurality of client devices.

17. The animation apparatus of claim 16, further comprising a dedicated processor configured to implement one or more iterations of the processing stack.

18. The animation apparatus of claim 16, wherein the processor or the dedicated processor are configured to execute a real-time graphics engine.

19. A distributed animation system comprising
a host device configured to maintain a model of an animated scene; and
a plurality of client devices connected to the host device via real-time links, wherein the host device is further configured to maintain a model of an animated scene, establish real-time links to a plurality of client devices, continuously receive updates from the plurality of client devices, each update associated with an animation aspect, update the model with a processing stack based on the received updates in a plurality of iterations, each iteration using updates associated with one animation aspect, and distribute indications of the updated model via the real-time links to the plurality of client devices.
